(19) United States
(12) Patent Application Publication
(10) Pub. No.: US 2007/0147092 A1
(43) Pub. Date: Jun. 28, 2007

(54) Backlight module with frame stopper for light guide plate and liquid crystal display with same

(75) Inventors: Zhi-Feng Fu, Shenzhen (CN); Bin Xu, Shenzhen (CN); Ke Lin, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,144

(22) Filed: Dec. 20, 2006

(30) Foreign Application Priority Data
Dec. 22, 2005 (CN) 200510121012.0

(51) Int. Cl. F21V 7/04

(52) U.S. Cl. 362/633

(57) ABSTRACT

An exemplary backlight module includes a light guide plate (12), an illuminator (14), and a frame (16) receiving the light guide plate and the illuminator. The light guide plate includes a light incident surface (122) and has a cutout defined in a corner thereof at one end of the light incident surface. The illuminator is located adjacent to the light incident surface. The frame includes a stopper (166) engagingly received in the cutout such that the stopper blocks movement of the light guide plate toward the illuminator.

### FIELD OF THE INVENTION

The present invention relates to backlight modules such as those used in liquid crystal displays (LCDs), and more particularly to a backlight module that has a frame stopper blocking a light guide plate thereof.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 13, a typical backlight module 13 includes a light guide plate 131, a light source 132, a reflective film 133, and a frame 134. The light guide plate 131 includes a light incident surface 135, a light emitting surface 136 perpendicularly connected with the light incident surface 135, and a bottom surface 137 opposite to the light emitting surface 136. The reflective film 133 is located adjacent to the bottom surface 137 of the light guide plate 131.

The light source 132 includes an illuminator 138 located adjacent to the light incident surface 135, and a reflector 139 cooperating with the light incident surface 135 to generally surround the illuminator 138. A height of the reflector 139 is slightly larger than a thickness of the light guide plate 131, and end portions (not labeled) of the light emitting surface 136 and the bottom surface 137 are covered by respective portions (not labeled) of the reflector 139.

However, the end portions of the light emitting surface 136 and the bottom surface 137 covered by the reflector 139 occupy only a very small area. Therefore when the backlight module 13 is subjected to vibration or shock during operation or transportation, the light guide plate 131 is liable to shift and move toward the illuminator 138. When this happens, the illuminator 138 is liable to impact on the light guide plate 131 and optical performance of the backlight module 13 may be seriously impaired as a result.

What is needed, therefore, is a backlight module that can overcome the above-described deficiency. What is also needed is a liquid crystal display including the backlight module.

### SUMMARY

In one preferred embodiment, a backlight module includes a light guide plate, an illuminator, and a frame receiving the light guide plate and the illuminator. The light guide plate includes a light incident surface and has a cutout defined in a corner thereof at one end of the light incident surface. The illuminator is located adjacent to the light incident surface. The frame includes a stopper engagingly received in the cutout such that the stopper blocks movement of the light guide plate toward the illuminator.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of a backlight module according to a first embodiment of the present invention.

FIG. 2 is an assembled view of the backlight module of FIG. 1.

FIG. 3 is an enlarged view of a circled portion III of FIG. 2.

FIG. 4 is similar to FIG. 3, but showing a view corresponding to a backlight according to a second embodiment of the present invention.

FIG. 5 is similar to FIG. 3, but showing a view corresponding to a backlight module according to a third embodiment of the present invention.

FIG. 6 is similar to FIG. 3, but showing a view corresponding to a backlight module according to a fourth embodiment of the present invention.

FIG. 7 is similar to FIG. 3, but showing a view corresponding to a backlight module according to a fifth embodiment of the present invention.

FIG. 8 is similar to FIG. 3, but showing a view corresponding to a backlight module according to a sixth embodiment of the present invention.

FIG. 9 is similar to FIG. 3, but showing a view corresponding to a backlight module according to a seventh embodiment of the present invention.

FIG. 10 is an exploded, isometric view of a backlight module according to an eighth embodiment of the present invention.

FIG. 11 is an exploded, isometric view of a backlight module according to a ninth embodiment of the present invention.

FIG. 12 is a side-on view of an exemplary liquid crystal display of the present invention, the liquid crystal display including the backlight module of FIG. 1.

FIG. 13 is a side-on, cross-sectional view of a conventional backlight module.

### DETAILED DESCRIPTION OF PREFERRED EMBODIMENTS

Reference will now be made to the drawings to describe the preferred embodiments in detail.

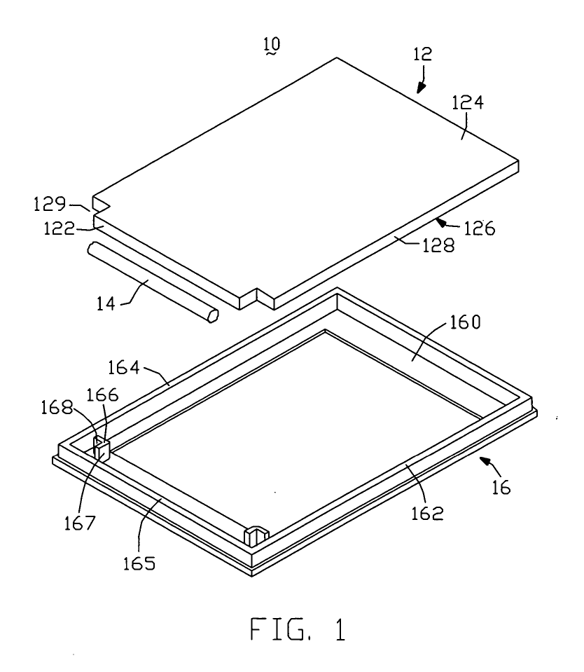

In FIG. 1, a backlight module 10 according to a first embodiment of the present invention is shown. The backlight module 10 includes a light guide plate 12, an illuminator 14, and a frame 16.

The light guide plate 12 includes a light incident surface 122, a light emitting surface 124, a bottom surface 126, and two opposite side surfaces 128. The light emitting surface 124 is perpendicularly connected with the light incident surface 122. The bottom surface 126 is on an opposite side of the light guide plate to the light emitting surface 124. The side surfaces 128 are oriented perpendicular to the light incident surface 122, and are perpendicularly connected with the light emitting surface 124 and the bottom surface 126. That is, the light incident surface 122, and the side surfaces 128 extend between the light emitting surface 124 and the bottom surface 126. The light guide plate 12 defines two cutouts 129 at two adjacent corners (not labeled) thereof that are nearest to the light incident surface 122. In the illustrated embodiment, surfaces (not labeled) that define the cutout 129 of the light guide plate 12 are oriented perpendicularly to each other. The light guide plate 12 can for example be made from polycarbonate (PC) or polymethyl methacrylate (PMMA), and can be manufactured using an injection molding method.

In the illustrated embodiment, the illuminator 14 is a linear cold cathode fluorescent lamp (CCFL) for serving as a light source for the backlight module 10. A length of the illuminator 14 is shorter than that of the light incident surface 122. In an alternative embodiment, the illuminator 14 can also be a plurality of linearly arranged or arrayed light emitting diodes (LEDs).

The frame 16 is generally rectangular. The frame 16 includes an annularly rectangular supporting board 160, and an annular side wall 162 perpendicularly connected with the supporting board 160, thus defining a space (not labeled) for accommodating the light guide plate 12 and the illuminator 14. In the illustrated embodiment, the side wall 162 includes two opposite long sub-walls 164 and two opposite short sub-walls 165 perpendicularly connected end to end.

A pair of stoppers 166 perpendicularly extend from the supporting board 160. The stoppers 166 are located at two adjacent corners (not labeled) of the frame 16. In the illustrate embodiment, the stoppers 166 are L-shaped, and are integrally formed with the supporting board 160. The stoppers 166 each include a first arm 167, and a second arm 168. The first arm 167 perpendicularly extends towards the adjacent long sub-wall 164. The second arm 168 is substantially perpendicularly connected with the first arm 167, and perpendicularly points to the adjacent short sub-wall 165, defining a right-angled inner corner (not labeled) and a chamfered outer corner (not labeled).

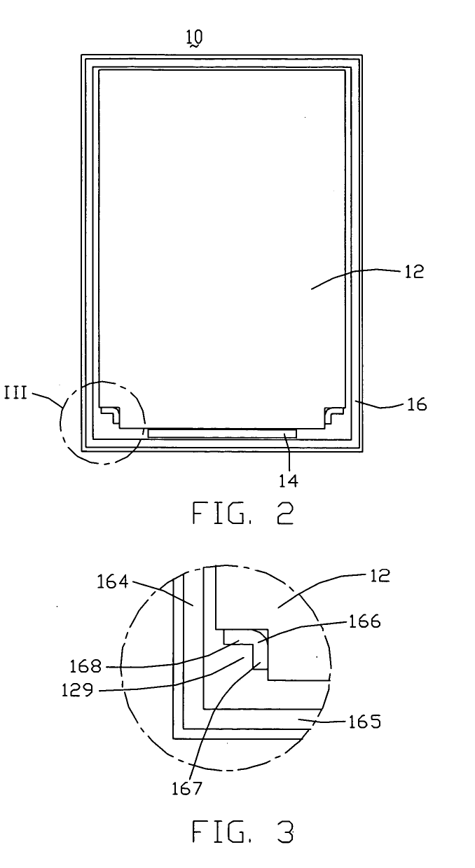

As is shown in FIG. 2 and FIG. 3, when the backlight module 10 is assembled, the light guide plate 12 and the illuminator 14 are received in the frame 16. The illuminator 14 is located adjacent to the light incident surface 122 of the light guide plate 12. The stoppers 166 are positioned in their respective cutouts 129. The first arms 167 and the second arms 168 fittingly their respective contact surfaces (not labeled) of the light guide plate 12 that define the cutouts 129. The above-described configuration means that the light guide plate 12 can be stopped from moving toward and contacting the illuminator 14. Thus, reliability of the backlight module 10 is improved, and optical performance of the backlight module 10 is both improved and maintained.

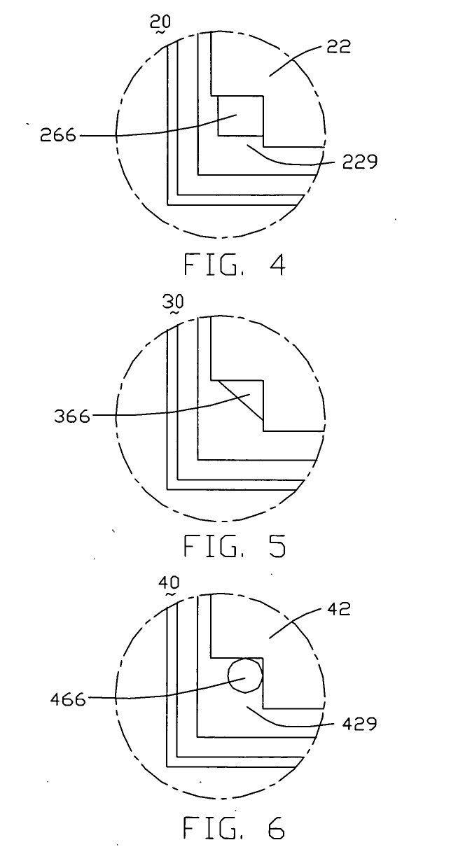

In FIG. 4, a backlight module 20 according to a second embodiment of the present invention similar to the backlight module 10 is shown. However, the backlight module 20 includes a stopper 266, and a light guide plate 22 defining a cutout 229. The stopper 266 has a substantially rectangular cross-section, and side surfaces (not labeled) thereof completely contact with corresponding surfaces that define the cutout 229 of the light guide plate 22. The backlight module 20 has advantages similar to those of the above-described backlight module 10.

In FIG. 5, a backlight module 30 according to a third embodiment of the present invention similar to the backlight module 10 is shown. However, a stopper 366 of the backlight module 30 has a triangular cross-section. In the illustrated embodiment, the stopper 366 has a triangular prism structure. The backlight module 30 has advantages similar to those of the above-described backlight module 10.

In FIG. 6, a backlight module 40 according to a fourth embodiment of the present invention similar to the backlight module 10 is shown. However, the backlight module 40 includes a stopper 466, and a light guide plate 42 defining a cutout 429. The stopper 466 has a circular cross-section, and tangentially contacts with side surfaces (not labeled) that define the cutout 429 of the light guide plate 42. In the illustrated embodiment, the stopper 466 has a cylindrical structure. The backlight module 40 has advantages similar to those of the above-described backlight module 10.

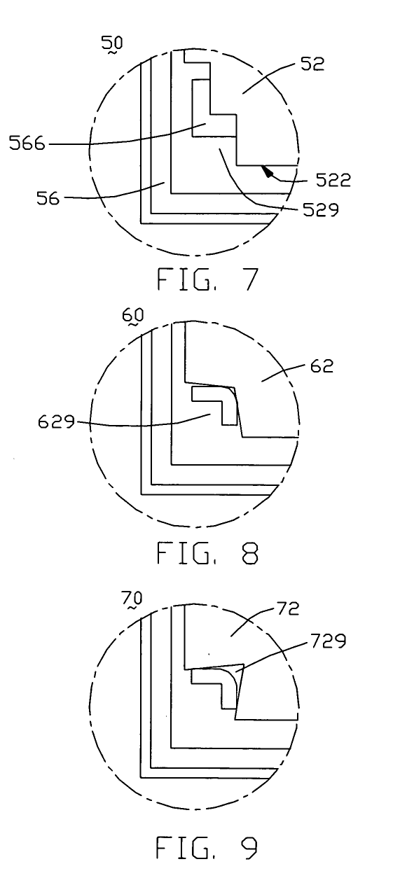

In FIG. 7, a backlight module 50 according to a fifth embodiment of the present invention similar to the backlight module 10 is shown. However, the backlight module 50 includes a light guide plate 52, and a frame 56 receiving the light guide plate 52. The light guide plate 52 defines a step (not labeled) at a corner thereof that is nearest to a light incident surface 522 thereof, and a cutout 529 is correspondingly defined at a point nearest to the light incident surface 522. The frame 56 includes an L-shaped stopper 566 fittingly contacting with corresponding surfaces of the step. The backlight module 50 has advantages similar to those of the above-described backlight module 10.

In FIG. 8, a backlight module 60 according to a sixth embodiment of the present invention similar to the backlight module 10 is shown. However, the backlight module 60 includes a light guide plate 62 defining a cutout 629. Surfaces that define the cutout 629 of the light guide plate 62 are inclined towards each other at an obtuse angle. The backlight module 60 has advantages similar to those of the above-described backlight module 10.

In FIG. 9, a backlight module 70 according to a seventh embodiment of the present invention similar to the backlight module 10 is shown. However, the backlight module 70 includes a light guide plate 72 defining a cutout 729. Surfaces that define the cutout 729 of the light guide plate 72 are inclined toward each other at a sharp angle. The backlight module 70 has advantages similar to those of the above-described backlight module 10.

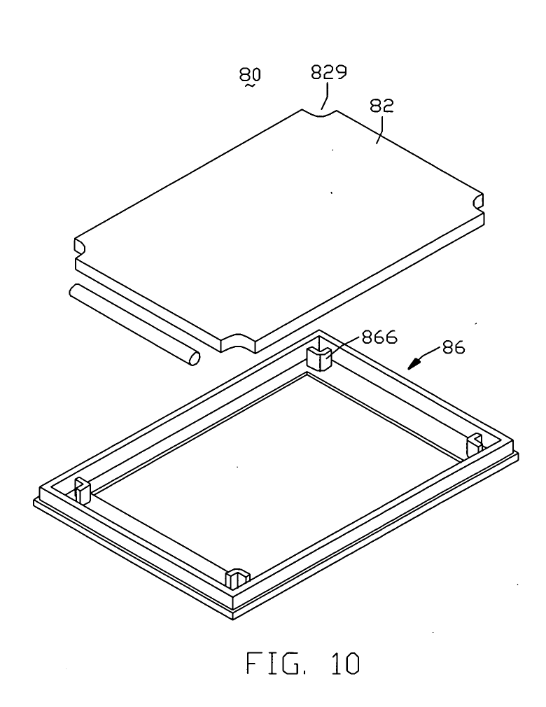

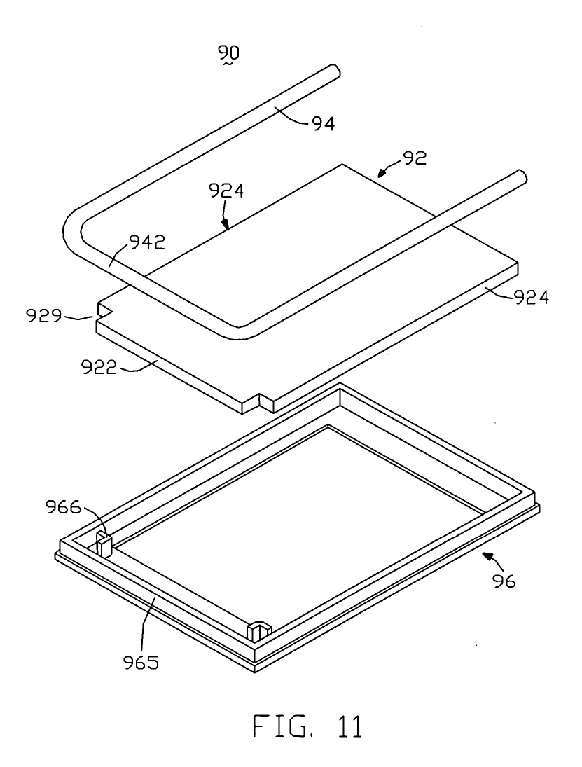

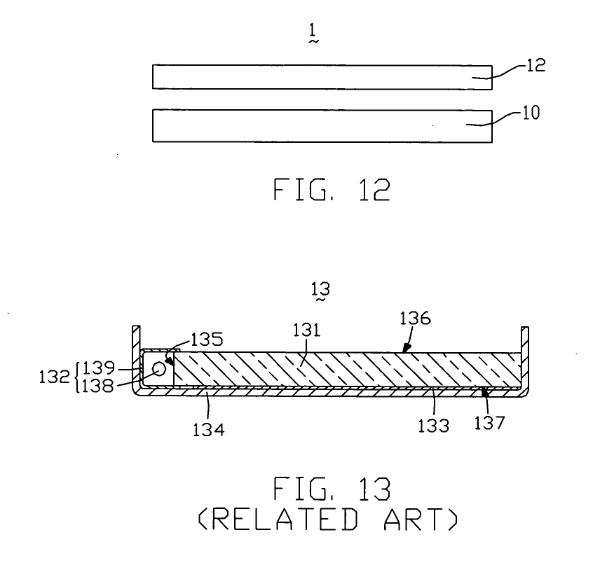

In FIG. 10, a backlight module 80 according to an eighth embodiment of the present invention similar to the backlight module 10 is shown. However, the backlight module 80 includes a light guide plate 82, and a frame 86 receiving the light guide plate 82. The light guide plate 82 respectively defines four cutouts 829 at four corners (not labeled) thereof, and surfaces that define the cutouts 829 of the light guide plate 82 are rounded. The frame 86 includes four stoppers 866 located at four respective corners (not labeled) thereof. The stoppers 866 each contact their respective surfaces. Reliability of the backlight module 80 is thus further improved.

In FIG. 11, a backlight module 90 according to a ninth embodiment of the present invention similar to the backlight module 10 is shown. However, the backlight module 90 includes a light guide plate 92, an illuminator 94, and a frame 96. The light guide plate 92 includes a light incident surface 922, and two side surfaces 924 on opposite sides of the light guide plate 92 and oriented perpendicular to the light incident surface 922. The light guide plate 92 further defines two cutouts 929 at two corners nearest to the light incident surface 922. The illuminator 94 has a symmetrical U-shape, and is located adjacent to the light incident surface 922 and the side surfaces 924 of the light guide plate 92. The frame 96 includes two stoppers 966 located at two adjacent corners (not labeled) thereof. A bottom portion 942 of the U-shaped illuminator 94 is located between the stoppers 966 and one short sub-wall 965 of the frame 96. The backlight module 90 thus has improved brightness.

In FIG. 12, a liquid crystal display 1 is shown including a liquid crystal panel 12, and the backlight module 10 located adjacent to the liquid crystal panel 12. In alternative embodiments, the backlight module 10 can be replaced with any one of the above-described backlight modules 20 to 90.

Further or alternative embodiments may include the following. In one example, the stoppers of the respective frames and the cutouts of the respective light guide plates can be combined. In such case, the frame includes the stoppers which correspond to the cutouts. In another example, the light guide plate only defines one cutout in a central portion of the light incident surface thereof. In this case, the frame includes only one stopper for preventing movement of the light guide plate.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight module comprising:
a light guide plate comprising:
a light incident surface;
a first side surface connected with the light incident surface; and
a second side surface connected with the first side surface, the second side surface and the first side surface cooperatively defining a cutout at a corner of the light guide plate that is nearest to the light incident surface;
an illuminator located adjacent to the light incident surface; and
a frame receiving the light guide plate and the illuminator, the frame comprising a stopper engagingly abutting the first side surface and the second side surface.

2. The backlight module in claim 1, wherein the first side surface is connected with the second side surface at a right angle.

3. The backlight module in claim 1, wherein the first side surface is connected with the second side surface by an obtuse angle.

4. The backlight module in claim 1, wherein the first side surface is connected with the second side surface at a sharp angle.

5. The backlight module in claim 1, wherein the stopper comprises a substantially L-shaped cross-section.

6. The backlight module in claim 1, wherein the stopper contacts the first side surface and the second side surface via planar contact.

7. The backlight module in claim 1, wherein the stopper contacts the first side surface and the second side surface via tangential contact.

8. The backlight module in claim 1, wherein the stopper comprises a substantially triangular cross-section.

9. The backlight module in claim 1, wherein the stopper comprises a substantially rectangular cross-section.

10. The backlight module in claim 1, wherein the stopper comprises a substantially circular cross-section.

11. The backlight module in claim 1, wherein the light guide plate further defines a step adjacent to the cutout at the corner.

12. The backlight module in claim 1, wherein the illuminator is linear.

13. The backlight module in claim 12, wherein the illuminator is a cold cathode fluorescent lamp.

14. The backlight module in claim 1, wherein the illuminator is substantially U-shaped.

15. A backlight module comprising:
a light guide plate comprising a light incident surface and having a cutout defined in a corner thereof at one end of the light incident surface;
an illuminator located adjacent to the light incident surface; and
a frame receiving the light guide plate and the illuminator, the frame comprising a stopper engagingly received in the cutout such that the stopper blocks movement of the light guide plate toward the illuminator.

16. A liquid crystal display comprising:
a liquid crystal panel; and
a backlight module adjacent the liquid crystal panel, the backlight module comprising:
a light guide plate comprising a light incident surface;
an illuminator located adjacent to the light incident surface and having a cutout defined in a corner thereof at one end of the light incident surface; and
a frame receiving the light guide plate and the illuminator, the frame comprising a stopper engagingly received in the cutout such that the stopper blocks movement of the light guide plate toward the illuminator.
